(19) United States
(12) Patent Application Publication
(10) Pub. No.: US 2017/0130727 A1
(43) Pub. Date: May 11, 2017

(54) Ornamental, Celebratory Hand Fan

(71) Applicant: Irvin Marlowe Deener, JR., Ashburn, VA (US)

(72) Inventor: Irvin Marlowe Deener, JR., Ashburn, VA (US)

(21) Appl. No.: 15/410,558

(22) Filed: Jan. 19, 2017

Related U.S. Application Data
(63) Continuation-in-part of application No. 29/538,449, filed on Sep. 3, 2015.
(60) Provisional application No. 62/280,463, filed on Jan. 19, 2016.

(51) Int. Cl. F04D 25/08; F21L 4/02; F21V 23/04; F21V 33/00

(52) U.S. Cl. CPC F04D 25/086; F21V 33/0096; F21V 33/008; F21L 4/02; F21V 23/0414; F21V 23/0407; F21W 2131/40

(57) ABSTRACT

An ornamental, celebratory hand fan that can be used to both cool a user and allow the user to support their favorite sports team, has a body, a plurality of lights, a power source, and a power control. The body depicts at least one sports item and is formed by a panel, a handle, and a base; the base and the panel being terminally connected to the handle opposite each other. The panel provides a large flat surface that is used to cool the user when manipulated by the handle. Meanwhile, the base prevents the users hand from slipping off of the handle. The plurality of lights are integrated into the body and enhance the visual appeal of the sports item depicted. The power source provides current to the plurality of lights, while the power control toggles the flow of current from the power source.

The current application claims a priority to the U.S. Provisional Patent application Ser. No. 62/280,463 filed on Jan. 19, 2016.

### FIELD OF THE INVENTION

The present invention relates generally to sports paraphernalia. More specifically, the present invention is an ornamental, celebratory hand fan that can be used to both cool a user and allow the user to support their favorite sports team.

### BACKGROUND OF THE INVENTION

People like to show their enthusiasm and attract attention when at sporting events. However, much of the sports paraphernalia sold and used at sporting events does not provide any functionality outside of showing one's support for the team. Oftentimes, sports stadiums can become overwhelmingly hot for stadium guests.

This can be due to outdoor stadiums in warm climates, or simply due to the large number of people packed into a relatively small space.

Therefore it is an object of the present invention to provide an ornamental, celebratory hand fan. The present invention allows a user to show their enthusiasm and attract attention while enjoying a sporting event, in addition to providing a functional fan that can be used to cool the user. Furthermore, the present invention has a plurality of lights that is integrated into a body that is designed according to the sports team or event.

### BRIEF DESCRIPTION OF THE DRAWINGS

FIG. 1 is a front elevational view of the present invention, wherein the panel and the handle depict a sports item, and the base depicts another sports item; the plurality of lights being integrated into the panel.

FIG. 2 is a front elevational view of the present invention, wherein the panel, the handle, and the base all depict one sports item; the plurality of lights being integrated into each of the panel, the handle, and the base.

FIG. 3 is a front elevational view of the present invention, wherein the panel and the base depict an identical sports item; the plurality of lights being integrated into the panel.

FIG. 4 is an electrical diagram depicting the electrical connections between the plurality of lights and the power source via the circuit board and the power control.

FIG. 5 is a front elevational view of the present invention, wherein a logo is positioned on the panel.

FIG. 6 is a front elevational view of the present invention, wherein a player number is positioned on the panel.

### DETAIL DESCRIPTIONS OF THE INVENTION

All illustrations of the drawings are for the purpose of describing selected versions of the present invention and are not intended to limit the scope of the present invention.

The present invention is an ornamental, celebratory hand fan that can be used to both cool a user and allow the user to support their favorite sports team. The present invention comprises a body 1, a plurality of lights 5, a power source 6, and a power control 7. The body 1 provides a hand operated, cooling mechanism that is designed in a stylistic sports theme. In this way, the present invention can be used to support a favorite sports team, while also providing the useful functionality of cooling the user. The body 1 can also be adapted to depict a variety of stylistic themes other than sports.

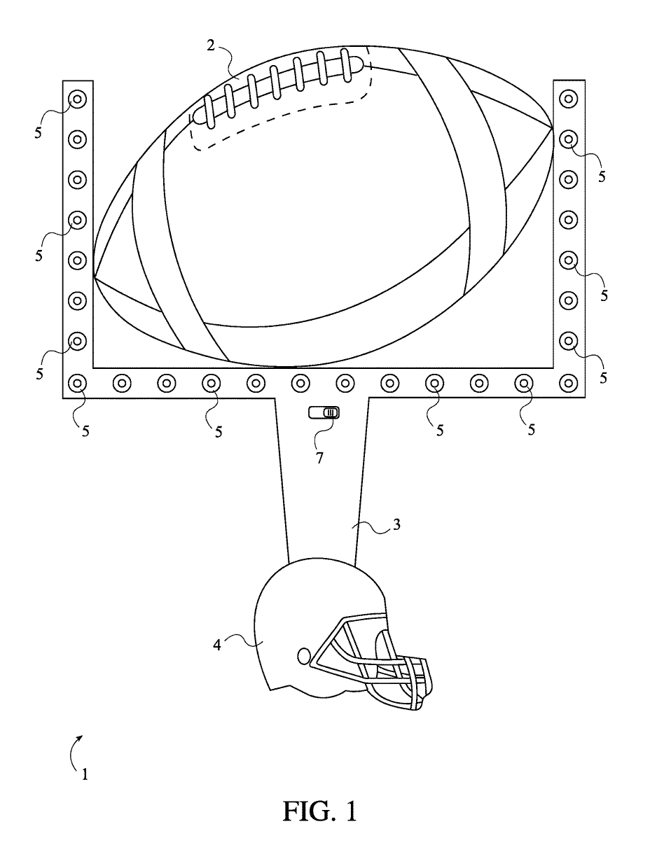

In reference to FIG. 1, the body 1 comprises a panel 2, a handle 3, and a base 4. The panel 2 provides a large, flat surface that is utilized to direct an airflow at a user. The panel 2 and the base 4 are terminally connected to the handle 3, wherein the panel 2 and the base 4 are positioned opposite each other along the handle 3. The handle 3 allows the user to grip the body 1, and manipulate the panel 2 in order to create an airflow that can be directed at the user or any other desired target. Furthermore, the handle 3 allows the user to manipulate the panel 2 in the essence of a sign, allowing the user to support their favorite sports team.

In further reference to FIG. 1, the base 4 prevents the user's hand from slipping off the end of the handle 3, allowing the user to securely grip and manipulate the handle 3. In the preferred embodiment of the present invention, the handle 3 tapers from the panel 2 to the base 4. This allows all users to comfortably grip the handle 3, wherein user's with larger hands can grip the handle 3 closer to the panel 2, and user's with smaller hands can grip the handle 3 closer to the base 4. In other embodiments, the handle 3 may taper in the opposite direction, or not taper at all.

The body 1 can be constructed from a sheet of foam, plastic, or any other suitable material that is durable along the intersection of the panel 2 and the handle 3, and the intersection of the base 4 and the handle 3. The body 1 can be constructed from a single piece of material or multiple pieces of material. If constructed from multiple pieces of material, the handle 3 is securely fastened to the panel 2 and/or the base 4 using an adhesive, ultrasonic welding, fasteners, or any other mechanism or method suitable for securely connecting the components together.

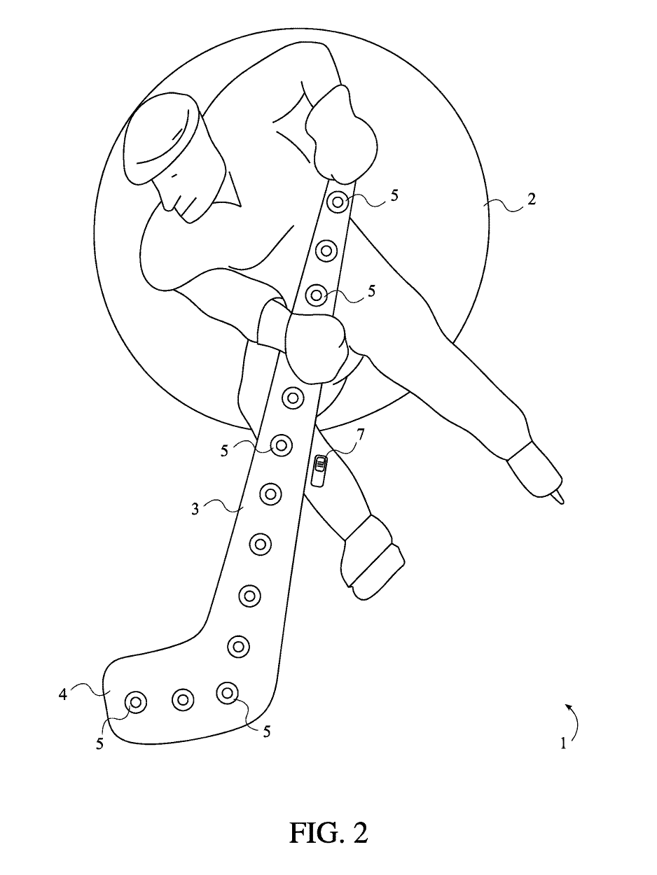

The body 1 is designed to depict one or more sports items for a given sport. Each of the panel 2, the handle 3, and the base 4 may individually depict a sports item, or one or more of the components may combine to depict a sports item. For example, in one embodiment, the panel 2 and the handle 3 combine together to depict a football going through a field goal post, while the base 4 depicts a football helmet, as shown in FIG. 1. In other embodiments, the panel 2 may depict a football helmet within a field goal post, just a football helmet, or another sports helmet. In another embodiment, the base 4 and the handle 3 combine together to depict a hockey stick, while the panel 2 depicts a hockey player and the background of a puck, as shown in FIG. 2.

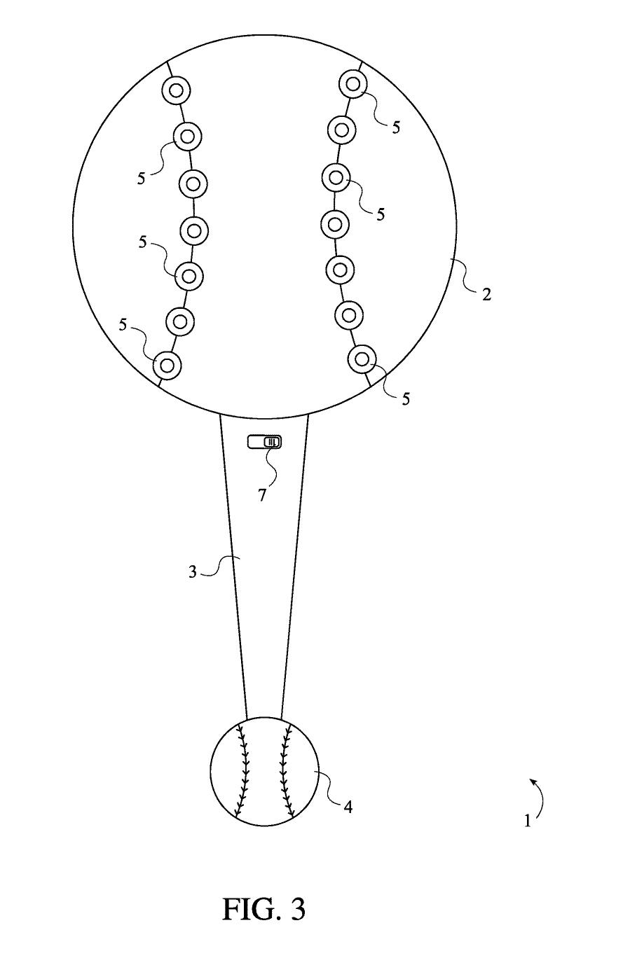

In yet another embodiment, the base 4 and the handle 3 combine together to depict a baseball bat, while the panel 2 depicts a baseball. In some embodiments, the panel 2 and the base 4 depict an identical sports item, but of different scale, as shown in FIG. 3; the base 4 being smaller than the panel 2. For example, the panel 2 and the base 4 may both depict a baseball, or a basketball, or a football, etc.

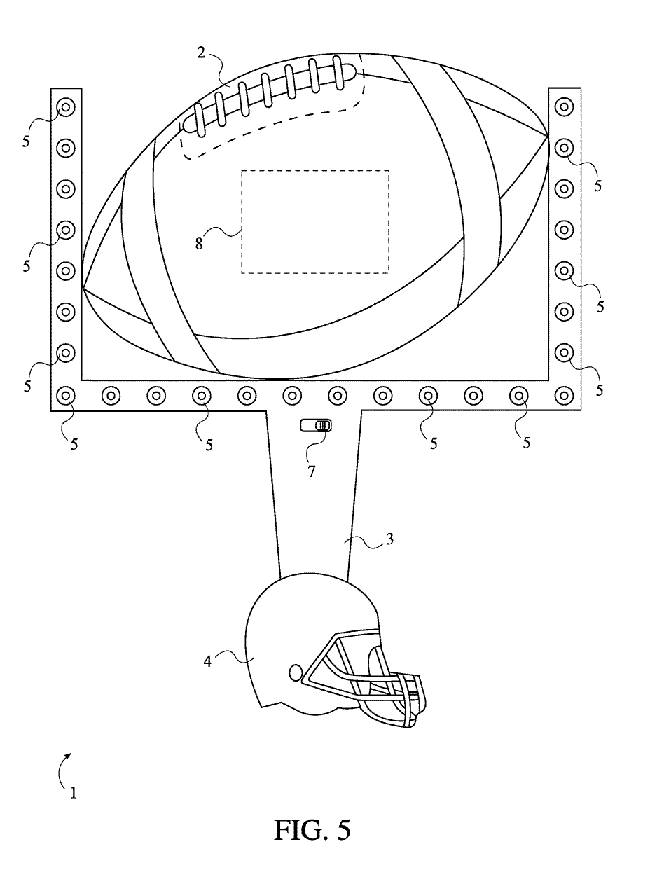

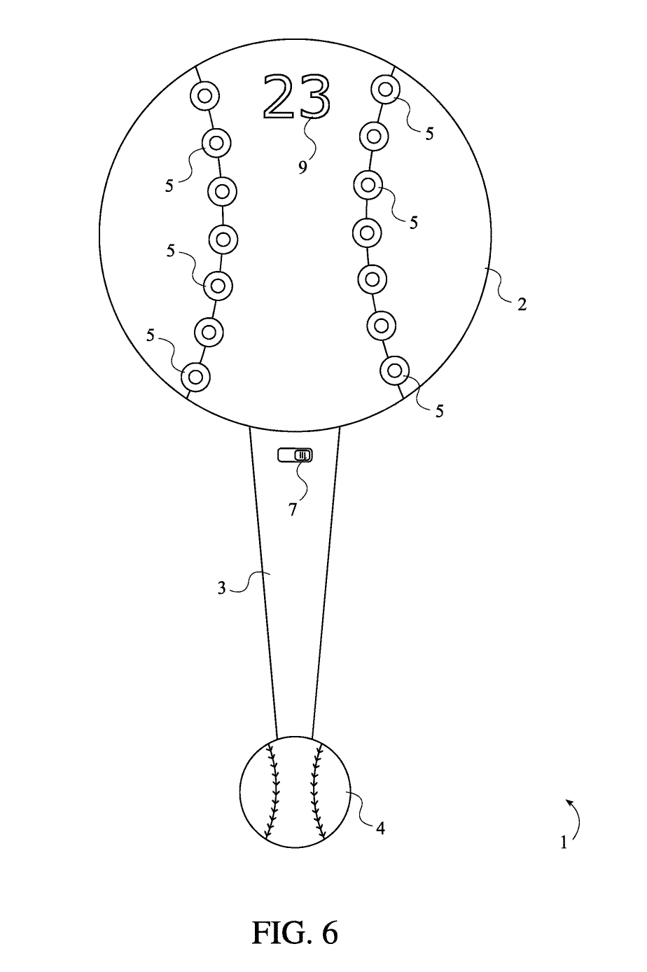

The present invention may also be utilized to depict a logo 8 or player number 9. The logo 8 can be for the sports team of which the present invention is designed to support, or that of a company sponsoring the sports team or sporting event. Meanwhile, the player number 9 corresponds to the jersey number of a particular player on the sports team. In reference to FIG. 5-6 respectively, the logo 8 or the player number 9 is positioned on the panel 2, such that it is prominently displayed when the user holds up, waves, or otherwise manipulates the present invention. It is also possible for the logo 8 or the player number 9 to be positioned on the base 4 in addition to, or in place of, on the panel 2.

In reference to FIG. 1, the plurality of lights 5 is mounted into the body 1 in a decorative fashion, wherein the orientation of the plurality of lights 5 is tied into the design depicted by the panel 2. For example, if the panel 2 depicts a football goal post, then the plurality of lights 5 may be positioned along the length of the cross bar and the uprights. The plurality of lights can be mounted into the panel 2, the handle 3, or the base 4 depending on the design of the body 1. In the preferred embodiment of the present invention, each of the plurality of lights 5 is a light emitting diode. However, it is possible for different types of lights to be utilized in other embodiments of the present invention.

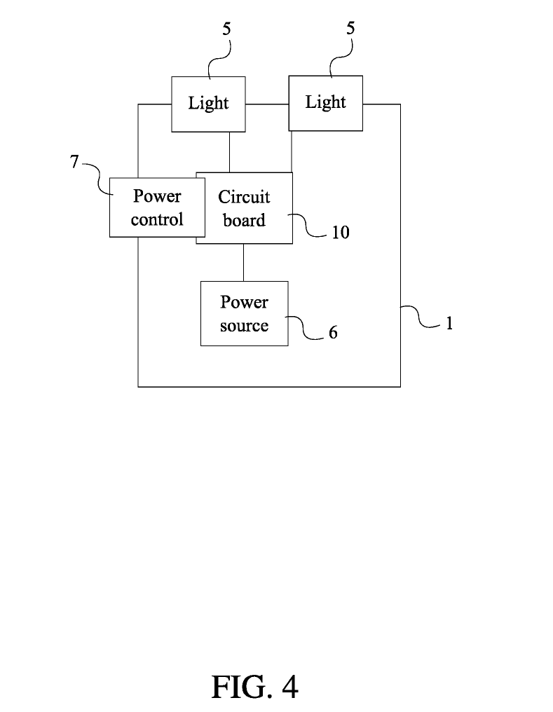

In reference to FIG. 4, the power source 6 is integrated into the body 1, and is used to provide electrical current to the plurality of lights 5. The power source 6 may be positioned within the handle 3, the base 4, or the panel 2. In the preferred embodiment of the present invention, the power source 6 is at least one battery. The battery may be rechargeable or non-rechargeable. If the battery is rechargeable, then a charging port may be provided. If the battery is non-rechargeable, then an access panel 2 may be provided, allowing the battery to be replaced.

In reference to FIG. 1, the power control 7 is mounted into the body 1, wherein the power control 7 is accessible to the user. The power control 7 is electrically connected in between the power source 6 and the plurality of lights 5, wherein the power control 7 is utilized to toggle the plurality of lights 5 on and off. In one embodiment, the power control 7 is a switch. In another embodiment, the power control 7 is a button. In the preferred embodiment of the present invention, the power control 7 is mounted into the handle 3, and is positioned adjacent to the panel 2.

In reference to FIG. 4, in some embodiments, the present invention may further comprise a circuit board 10, wherein the power control 7 is electrically connected in between the plurality of lights 5 and the power source 6 via the circuit board 10. The circuit board 10 is programmed with light settings that can be selected using the power control 7. If the power control 7 is a switch, then multiple switch positions may be provided for selecting the desired light setting. If the power control 7 is a button, then the circuit board 10 may be configured to cycle to a subsequent light setting each time the power control 7 is engaged.

In one embodiment, the light settings includes an on state, an off state, and one or more flashing states. In the on state, current is constantly supplied to the plurality of lights 5, wherein each of the plurality of lights 5 is constantly illuminated. In the off state, current is cut off from each of the plurality of lights 5. In the one or more flashing states, current is intermittently supplied to the plurality of lights 5, wherein each of the plurality of lights 5 flashes at a pre-determined rate. The one or more flashing states may also include an alternating flash pattern, in which multiple sets of lights are alternately illuminated. Furthermore, the one or more flashing states may include alternating the plurality of lights 5 between a first color and a second color.

In the preferred embodiment, each of the plurality of lights 5 emits a light color corresponding to one of the team colors of the team the body 1 is designed to support. In other embodiments, the light settings allow the user to select different color patterns for the plurality of lights 5. For example, pressing the power control 7 once may illuminate the plurality of lights 5 in the first color; pressing the power control 7 a second time may illuminate the plurality of lights 5 in the second color; pressing the power control 7 a third time may illuminate the plurality of lights 5 in a combination of the first color and the second color; and pressing the power control 7 a fourth time may illuminate the plurality of lights 5 in an alternating pattern of the first color and the second color. Although the invention has been explained in relation to its preferred embodiment, it is to be understood that many other possible modifications and variations can be made without departing from the spirit and scope of the invention as hereinafter claimed.

What is claimed is:

1. An ornamental, celebratory hand fan comprises:
a body;
a plurality of lights;
a power source;
a power control;
the body comprising a panel, a handle, and a base;
the panel and the base being terminally connected to the handle;
the panel and the base being positioned opposite each other along the handle;
the plurality of lights being mounted into the body;
the power control being electrically connected in between the power source and the plurality of lights;
the power control being mounted into the body; and
the power source being integrated into the body.

2. The ornamental, celebratory hand fan as claimed in claim 1 comprises:
the plurality of lights being mounted into the panel;

3. The ornamental, celebratory hand fan as claimed in claim 1 comprises:
the plurality of lights being mounted into the handle;

4. The ornamental, celebratory hand fan as claimed in claim 1 comprises:
the plurality of lights being mounted into the base;

5. The ornamental, celebratory hand fan as claimed in claim 1 comprises:
a logo; and
the logo being positioned on the panel.

6. The ornamental, celebratory hand fan as claimed in claim 1 comprises:
a player number; and
the player number being positioned on the panel.

7. The ornamental, celebratory hand fan as claimed in claim 1, wherein each of the plurality of lights is a light emitting diode.

8. The ornamental, celebratory hand fan as claimed in claim 1 comprises:
the power control being mounted into the handle; and
the power control being positioned adjacent to the panel.

9. The ornamental, celebratory hand fan as claimed in claim 1, wherein the power control is a switch.

10. The ornamental, celebratory hand fan as claimed in claim 1, wherein the power control is a button.

11. The ornamental, celebratory hand fan as claimed in claim 1, wherein the handle tapers from the panel to the base.

12. The ornamental, celebratory hand fan as claimed in claim 1 comprises:
a circuit board; and
the power control being electrically connected in between the plurality of lights and the power source via the circuit board.
